(19) United States
(12) Patent Application Publication
(10) Pub. No.: US 2011/0195300 A1
(43) Pub. Date: Aug. 11, 2011

(54) STACKED LITHIUM ION SECONDARY BATTERY

(75) Inventors: Takao Daidoji, Kanagawa (JP); Tsuyoshi Inose, Kanagawa (JP)

(73) Assignee: NEC ENERGY DEVICES, LTD., Kanagawa (JP)

(21) Appl. No.: 13/123,401

(22) PCT Filed: Oct. 19, 2009
(86) PCT No.: PCT/JP2009/005455

§ 371 Date: Apr. 8, 2011

(30) Foreign Application Priority Data
Oct. 20, 2008 (JP) 2008-269578

(51) Int. Cl. H01M 10/05; H01M 10/02; H01M 10/36

(52) U.S. Cl. 429/153

(57) ABSTRACT

A stacked lithium ion secondary battery is characterized in that: a positive terminal is taken out from positive electrodes of a battery element stack in which the positive electrodes and negative electrodes are stacked via separators; a negative terminal is taken out from the negative electrodes; the battery element stack, except the taken-out portions of the positive and negative terminals, is covered with a porous plastic film; and an opening of the battery element stack covered with the porous plastic film is sealed with a film-like covering material.

### TECHNICAL FIELD

The present invention relates to a stacked lithium ion secondary battery in which the whole surface of a battery element stack is covered with a porous plastic film.

### BACKGROUND ART

In recent years, as a power source for portable devices such as cellular phones or digital still cameras, a lithium ion secondary battery has been used as demand for high-capacity, small batteries grows. For a power source of an electric bicycle, electric vehicle or electric tool, a lithium ion secondary battery with high energy density and no memory effect is used. Accordingly, a long-life lithium ion secondary battery with high volume and mass energy densities is required.

What is proposed is a stacked lithium ion secondary battery in which a plurality of plate-like positive and negative electrodes are stacked via separators, electrode terminals that are connected to the electrodes are connected in parallel, and a film-like covering material that has an advantage in terms of the battery's energy density is used.

The stacked lithium ion secondary battery includes a battery element stack in which a plurality of positive and negative electrodes are stacked via separators in such a way that the positive and negative electrodes face each other across separators. The positive and negative terminals that are each connected to the positive and negative electrodes are spaced out in such a way that the positive and negative terminals do not come in contact with each other, and the positive and negative terminals are connected in parallel. An opening is sealed with the film-like covering material so that an electrolytic solution is held.

FIG. 6 is a diagram illustrating an example of a battery element stack of a conventional lithium ion secondary battery.

Around a central portion of each of the four sides of a battery element stack 20 in which positive and negative electrodes 1 and 2 stored in a plurality of bag-shaped separators 3 are stacked and disposed so as to face each other, the positive electrodes, the separators and the negative electrodes are bound together at four points with adhesive tapes 21 so that the positive electrodes, the separators and the negative electrodes do not move: The adhesive tapes 21 are about 20 mm wide and made of polypropylene or the like.

What is also proposed is a battery in which an electrolytic solution spreads nicely into battery elements: In the battery, an adhesive tape is wound around a battery element stack so that battery elements are fixed, and a space is provided in order for the adhesive tape not to adhere to a side of the battery element stack. For example, see Patent Document 1.

### PRIOR ART DOCUMENT

### Patent Document

Patent Document 1: JP-A-2002-198098

### DISCLOSURE OF THE INVENTION

### Problems to be Solved by the Invention

The problem is that in the stacked lithium ion secondary battery, if the electrolytic solution does not spread sufficiently into the battery elements, decreases of battery characteristics such as capacity retention occur as a charge-discharge cycle is repeated.

Moreover, when, around a central portion of each of the four sides of a battery element stack in which positive and negative electrodes are stacked via separators, the positive and negative electrodes and the separators are bound together at four points with adhesive tapes about 20 mm wide so that the positive and negative electrodes and the separators do not move, the problem is that the outermost-layer electrode may break along an attachment edge of the adhesive tape due to external forces or the like.

When a space is formed at a side face of a battery element stack as in the case of Patent Document 1, there is a fear that the volume energy density might decrease and that electrodes might move due to external shocks since the electrodes are not fixed relative to a direction in which electrode terminals are taken out.

The present invention is aimed at making smooth the holding of an electrolytic solution and the supply of the electrolytic solution to a battery element stack and improving a cycle characteristic of a battery. The present invention is also aimed at providing a stacked lithium ion secondary battery designed to prevent the battery element stack, in which positive electrodes, separators and negative electrodes are stacked, from moving without sticking adhesive tapes or the like to the positive or negative electrodes so that an electrode does not break from an attachment edge face of an adhesive tape.

### Means for Solving the Problems

According to the present invention, in a stacked lithium ion secondary battery, a positive terminal is taken out from positive electrodes of a battery element stack in which the positive electrodes and negative electrodes are stacked via separators; a negative terminal is taken out from the negative electrodes; the battery element stack, except the taken-out portions of the positive and negative terminals, is covered with a porous plastic film; and an opening of the battery element stack covered with the porous plastic film is sealed with a film-like covering material.

In the stacked lithium ion secondary battery, the battery element stack is sealed by thermal contraction of the porous plastic film.

In the stacked lithium ion secondary battery, the porous plastic film has a porosity of 20% to 60% and a thickness of 20 μm to 100 μm.

### Advantages of the Invention

According to the present invention, since the whole surface of the battery element stack is covered with the porous plastic film and sealed by thermal contraction, it is possible to hold an electrolytic solution in the porous plastic film and improve a cycle characteristic. Since the electrolytic solution is kept in the porous plastic film, it is possible to reduce the amount of electrolytic solution spewing out when the pressure inside the battery is reduced for sealing during a process of producing the battery.

Moreover, it is not necessary to stick adhesive tapes or the like to fix the battery element stack. The battery element stack as a whole is stored in the porous plastic film. Therefore, it is possible to provide a stacked lithium ion secondary battery in which an electrode does not break from an attachment edge face of an adhesive tape even if an external force or the like is applied during a process of producing the battery element stack.

### BRIEF DESCRIPTION OF THE DRAWINGS

FIG. 1 is a diagram illustrating a battery element stack of a stacked lithium ion secondary battery according to the present invention.

FIG. 2 is a diagram illustrating a bag-shaped porous body made of a porous plastic film.

FIG. 3 is a diagram illustrating a battery element stack/bag-shaped porous body complex.

FIG. 4 is a diagram illustrating the battery element stack/bag-shaped porous body complex in which positive and negative terminals are connected to positive and negative electrodes, respectively.

FIG. 5 is a diagram illustrating the stacked lithium ion secondary battery whose opening is sealed with a film-like covering material of the present invention.

FIG. 6 is a diagram illustrating an example of a battery element stack of a conventional stacked lithium ion secondary battery.

### BEST MODE FOR CARRYING OUT THE INVENTION

Hereinafter, the present invention will be described with reference to the accompanying drawings.

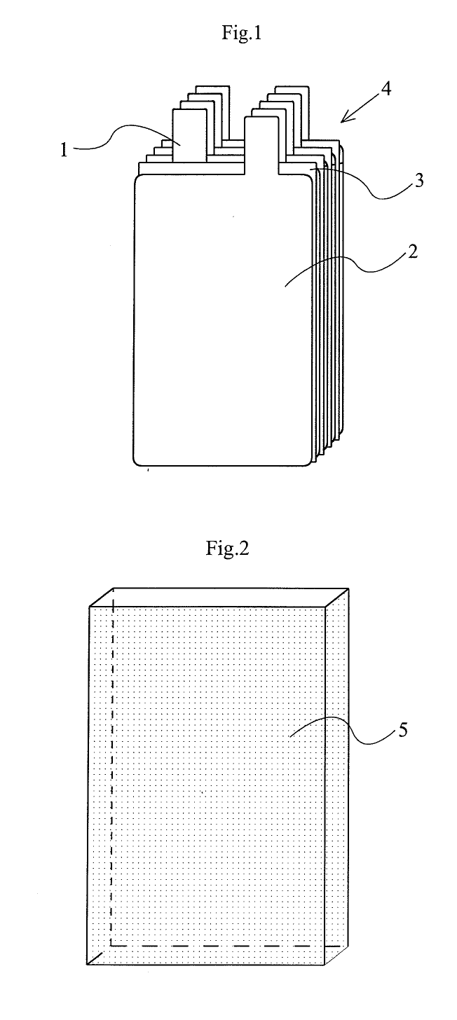

FIG. 1 is a diagram illustrating a battery element stack of a stacked lithium ion secondary battery according to the present invention.

The following are alternately stacked to make a battery element stack 4: positive electrodes 1, in which a positive-electrode active material such as lithium-manganese composite oxide that stores or releases lithium ions is applied on aluminum foil and which are put into bag-shaped separators 3 made of polypropylene, polyethylene, or a porous film of a three-layer structure of polypropylene/polyethylene/polypropylene; and negative electrodes 2, in which a negative-electrode active material such as graphite that stores or releases lithium ions is applied on copper foil.

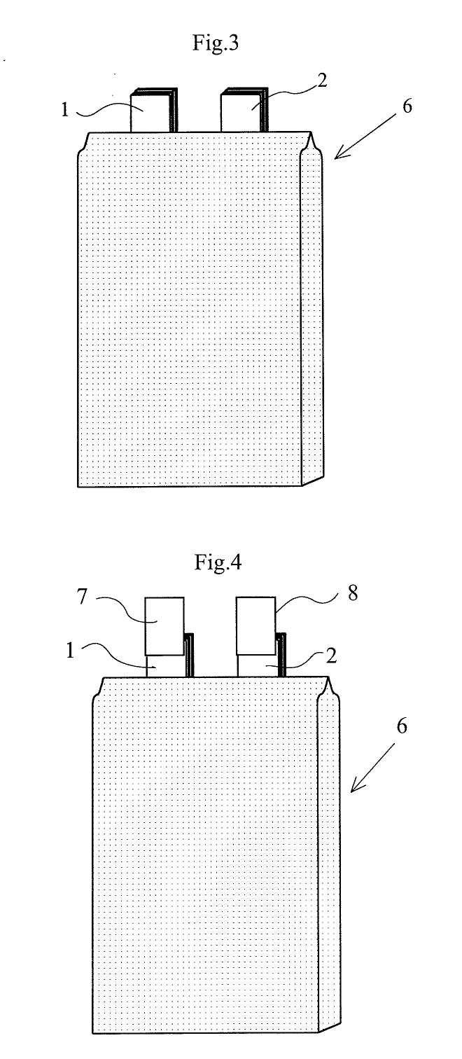

Then, into a bag-shaped porous body 5 shown in FIG. 2 that is made of a porous plastic film, the produced battery element stack 4 is put as shown in FIG. 3 before being impregnated with an electrolytic solution. An opening of an upper section is heated. The positive and negative electrodes 1 and 2 are combined together due to thermal contraction. Therefore, a battery element stack/bag-shaped porous body complex 6 is produced.

Then, as shown in FIG. 4, a positive terminal 7 is connected to a plurality of positive electrodes 1 of the battery element. Similarly, a negative terminal 8 is connected to a plurality of negative electrodes 2.

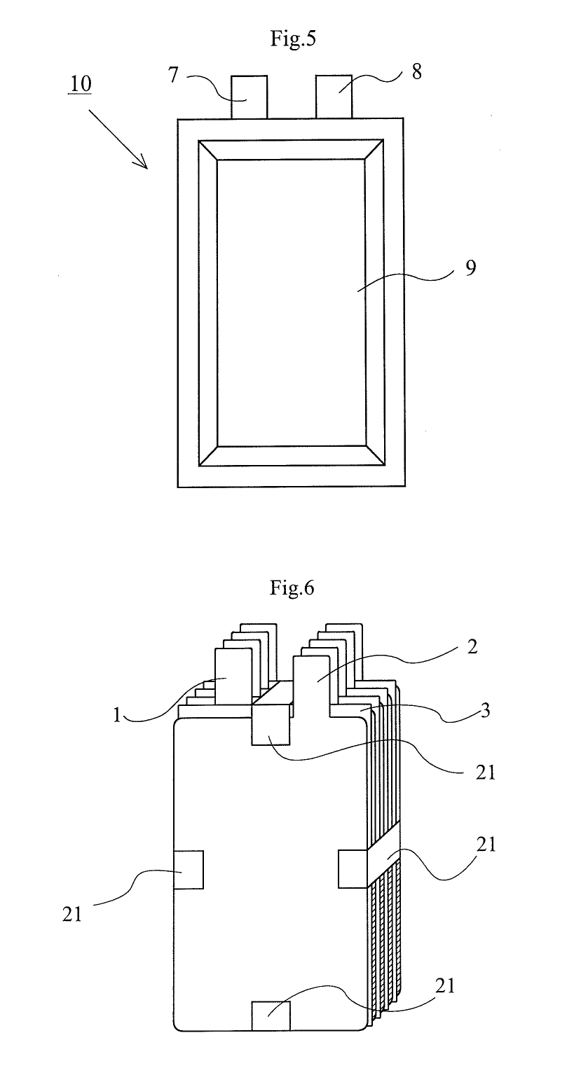

After the positive and negative terminals 7 and 8 are connected, an opening of the battery element stack/bag-shaped porous body complex 6 is sealed with a film-like covering material 9 as shown in FIG. 5. Therefore, what is produced is a stacked lithium ion secondary battery 10 whose opening is sealed with the film-like covering material 9.

Incidentally, the following is also possible: a porous plastic film, instead of the above bag-shaped porous body 5, covers the whole surface of the battery element stack 4, and the battery element stack/bag-shaped porous body complex is produced due to thermal contraction of the porous plastic film.

### EXAMPLES

### Example 1

Positive electrodes, each 0.18 mm in thickness, are put into bag-shaped separators made of a porous film of a three-layer structure of polypropylene/polyethylene/polypropylene. Fourteen such positive electrodes and 15 negative electrodes, each 0.1 mm in thickness, are alternately stacked to produce a battery element stack that is 70 mm wide, 125 mm long and 5 mm in thickness. The stack is stored with the use of a porous plastic film that is 30 μm in thickness and made of a porous film of a three-layer structure of polypropylene/polyethylene/polypropylene with a porosity of 40% before being impregnated with the following electrolytic solution: a mixed solution of ethylene carbonate and diethylene carbonate containing 1 mol/L of LiPF₆.

The stack is then covered with a film-like covering material made of polyethylene/aluminum/polyethylene terephthalate. A portion on which the film-like covering material is put is heated under a pressure of 0.4 MPa at 160 degrees Celsius so that an opening is sealed. In this manner, 96 stacked lithium ion secondary batteries are produced with the openings sealed with the film-like covering material.

A cycle charge-discharge cycle test is conducted in the following manner: each of the produced lithium ion secondary batteries is charged with a constant current of 5.0 A, which is equivalent to 1 C, up to 4.2 V at 45 degrees Celsius before the operation switches to constant-voltage charging, and, after the constant-current/constant-voltage charging operation is performed for 2.5 hours in total, a 5.0 A constant-current discharge operation is repeated until the battery voltage drops to 3.0 V. Table 1 shows an arithmetic mean value thereof when the number of cycles needed for the discharge capacity to drop to half the first capacity is regarded as the number of cycles of a capacity retention of 50%.

### Comparative Example 1

As in the case of Example 1, what is produced is a stack where bag-shaped separators, in which positive electrodes are stored, and negative electrodes are alternately stacked; the stack is 70 mm wide, 125 Trim long and 5 mm in thickness. The stack is bound together at 4 points in a central portion of each edge with adhesive tapes made of polypropylene that are 20 mm wide. The stack is then covered with a film-like covering material made of polyethylene/aluminum/polyethylene terephthalate. The same amount of electrolytic solution as in Example 1 is poured. A portion on which the film-like covering material is put is heated under a pressure of 0.4 MPa at 160 degrees Celsius so that an opening is sealed. In this manner, 96 stacked lithium ion secondary batteries of comparative sample 1 are produced with the openings sealed with the film-like covering material.

In a similar way to that of Example 1, a charge-discharge test is conducted on each comparative sample to count the number of cycles needed for the discharge capacity to drop to half the first capacity. Table 1 shows an arithmetic mean value thereof.

The results show that the cycle characteristic is better in the stacked lithium ion secondary battery in which the battery element stack is stored in the porous plastic film.

After the charge-discharge test is conducted on the stacked lithium ion secondary batteries produced in Example 1 and Comparative Example 1, the stacked lithium ion secondary batteries are disassembled and compared. The results show that 5.2% of the stacks that are bound together with adhesive tapes made of polypropylene have had the outermost-layer negative electrodes broken from the attachment edge faces of the adhesive tapes made of polypropylene. In the case of Example 1, in which the stack is stored in the bag-shaped porous plastic film, the electrodes do not break.

In the process of producing the battery of Example 1, the electrolytic solution does not spew out and other problems do not occur when the pressure is reduced and the battery is sealed with the film-like covering material. In the process of producing the battery of Comparative Example 1, however, the electrolytic solution spews out when the battery is sealed.

### Example 2

As in the case of Example 1, what is produced is a battery element stack where bag-shaped separators, in which positive electrodes are stored, and negative electrodes are alternately stacked; the battery element stack is 70 mm wide, 125 mm long and 5 mm in thickness. For a porous plastic film that is 30 μm in thickness, the same material used for the separators in which the positive electrodes are stored is used; the stack is stored therein. A pressure of 3 Mpa and a heat of 85 degrees Celsius are applied thereto in the thickness direction of the stack so that the stack is sealed by thermal contraction.

Then, the stack is cooled down to 25 degrees Celsius and impregnated with an electrolytic solution. With the battery element stack stored in the film-like covering material and the film-like covering materials put together, 30 stacked lithium ion secondary batteries are produced.

In a similar way to that of Example 1, a charge-discharge test is conducted on the produced lithium ion secondary batteries. Table 1 shows arithmetic mean values when the number of cycles needed for the discharge capacity to come down to half the first capacity is regarded as the number of cycles of a capacity retention of 500.

TABLE 1

| Example | Number of cycles of | Electrode breakage |
|---|---|---|
| number | 50% capacity retention | rate (%) |
| Example 1 | 701 | 0 |
| Example 2 | 689 | 0 |
| Com. Ex. 1 | 522 | 5.2 |

### Example 3

What is produced is a battery element stack where bag-shaped separators, in which positive electrodes are stored, and negative electrodes are alternately stacked; the battery element stack is 70 mm wide, 125 mm long and 5 mm in thickness. The battery element stack is stored in a porous plastic film; the porous plastic film is different from that in Example 1 in that the porosity is 20% and the thickness is 30 μm, but the rest of the characteristics are the same.

Then, the porous plastic film, in which the battery element stack is stored, is put into the film-like covering material and the film-like covering materials are put together. Under a pressure of 0.4 MPa, a temperature of 160 degrees Celsius is applied so that an opening is sealed. In this manner, 5 stacked lithium ion secondary batteries are produced.

In a similar way to that of Example 1, a charge-discharge test is conducted to count the number of cycles needed for the discharge capacity to drop to 50% of the first capacity. Table 2 shows an arithmetic mean value thereof.

### Example 4

Five stacked lithium ion secondary batteries are produced in a similar way to that of Example 3, except that a porous plastic film with a porosity of 30% and a thickness of 30 μm is used.

In a similar way to that of Example 1, a charge-discharge test is conducted to count the number of cycles needed for the discharge capacity to drop to 50% of the first capacity. Table 2 shows an arithmetic mean value thereof.

### Example 5

Five stacked lithium ion secondary batteries are produced in a similar way to that of Example 3, except that a porous plastic film with a porosity of 40% and a thickness of 30 μm is used.

In a similar way to that of Example 1, a charge-discharge test is conducted to count the number of cycles needed for the discharge capacity to drop to 50% of the first capacity. Table 2 shows an arithmetic mean value thereof.

### Example 6

Five stacked lithium ion secondary batteries are produced in a similar way to that of Example 3, except that a porous plastic film with a porosity of 50% and a thickness of 30 μm is used.

In a similar way to that of Example 1, a charge-discharge test is conducted to count the number of cycles needed for the discharge capacity to drop to 50% of the first capacity. Table 2 shows an arithmetic mean value thereof.

### Example 7

Five stacked lithium ion secondary batteries are produced in a similar way to that of Example 3, except that a porous plastic film with a porosity of 60%- and a thickness of 30 μm is used.

In a similar way to that of Example 1, a charge-discharge test is conducted to count the number of cycles needed for the discharge capacity to drop to 50% of the first capacity. Table 2 shows an arithmetic mean value thereof.

### Example 8

Five stacked lithium ion secondary batteries are produced in a similar way to that of Example 3, except that a porous plastic film with a porosity of 10% and a thickness of 30 μm is used.

In a similar way to that of Example 1, a charge-discharge test is conducted to count the number of cycles needed for the discharge capacity to drop to 50% of the first capacity. Table 2 shows an arithmetic mean value thereof.

### Example 9

Five stacked lithium ion secondary batteries are produced in a similar way to that of Example 3, except that a porous plastic film with a porosity of 70% and a thickness of 30 μm is used.

In a similar way to that of Example 1, a charge-discharge test is conducted to count the number of cycles needed for the discharge capacity to drop to 50% of the first capacity. Table 2 shows an arithmetic mean value thereof.

### Example 10

Five stacked lithium ion secondary batteries are produced in a similar way to that of Example 3, except that a porous plastic film with a porosity of 80% and a thickness of 30 μm is used.

In a similar way to that of Example 1, a charge-discharge test is conducted to count the number of cycles needed for the discharge capacity to drop to 50% of the first capacity. Table 2 shows an arithmetic mean value thereof.

TABLE 2

| | | Number of cycles of |
|---|---|---|
| Example number | Porosity (%) | 50% capacity retention |
| 3 | 20 | 690 |
| 4 | 30 | 703 |
| 5 | 40 | 686 |
| 6 | 50 | 690 |
| 7 | 60 | 695 |
| 8 | 10 | 560 |
| 9 | 70 | 563 |
| 10 | 80 | 559 |

It is clear from the results that a good cycle characteristic is obtained when the porosity of the porous plastic film is in the range of 20% to 60%.

### Example 11

Five stacked lithium ion secondary batteries are produced in a similar way to that of Example 3, except that a porous plastic film with a porosity of 40% and a thickness of 20 μm is used.

In a similar way to that of Example 1, a charge-discharge test is conducted to count the number of cycles needed for the discharge capacity to drop to 50% of the first capacity. Table 3 shows an arithmetic mean value thereof.

### Example 12

Five stacked lithium ion secondary batteries are produced in a similar way to that of Example 11, except that a porous plastic film with a thickness of 30 μm is used.

In a similar way to that of Example 1, a charge-discharge test is conducted to count the number of cycles needed for the discharge capacity to drop to 50% of the first capacity. Table 3 shows an arithmetic mean value thereof.

### Example 13

Five stacked lithium ion secondary batteries are produced in a similar way to that of Example 11, except that a porous plastic film with a thickness of 50 μm is used.

In a similar way to that of Example 1, a charge-discharge test is conducted to count the number of cycles needed for the discharge capacity to drop to 50% of the first capacity. Table 3 shows an arithmetic mean value thereof.

### Example 14

Five stacked lithium ion secondary batteries are produced in a similar way to that of Example 11, except that a porous plastic film with a thickness of 70 μm is used.

In a similar way to that of Example 1, a charge-discharge test is conducted to count the number of cycles needed for the discharge capacity to drop to 50% of the first capacity. Table 3 shows an arithmetic mean value thereof.

### Example 15

Five stacked lithium ion secondary batteries are produced in a similar way to that of Example 11, except that a porous plastic film with a thickness of 100 μm is used.

In a similar way to that of Example 1, a charge-discharge test is conducted to count the number of cycles needed for the discharge capacity to drop to 50% of the first capacity. Table 3 shows an arithmetic mean value thereof.

### Example 16

Five stacked lithium ion secondary batteries are produced in a similar way to that of Example 11, except that a porous plastic film with a thickness of 10 μm is used.

In a similar way to that of Example 1, a charge-discharge test is conducted to count the number of cycles needed for the discharge capacity to drop to 50% of the first capacity. Table 3 shows an arithmetic mean value thereof.

### Example 17

Five stacked lithium ion secondary batteries are produced in a similar way to that of Example 11, except that a porous plastic film with a thickness of 150 μm is used.

In a similar way to that of Example 1, a charge-discharge test is conducted to count the number of cycles needed for the discharge capacity to drop to 50% of the first capacity. Table 3 shows an arithmetic mean value thereof.

TABLE 3

| | Film thickness | Number of cycles of |
|---|---|---|
| Example number | (μm) | 50% capacity retention |
| 11 | 20 | 705 |
| 12 | 30 | 698 |
| 13 | 50 | 695 |
| 14 | 70 | 690 |
| 15 | 100 | 691 |
| 16 | 10 | 553 |
| 17 | 150 | 570 |

The cycle characteristic is good when the thickness of the porous plastic film is in the range of 20 μm to 100 μm.

### INDUSTRIAL APPLICABILITY

According to the present invention, the battery element stack, in which positive and negative electrodes are stacked and disposed via separators in such a way that the positive and negative electrodes face each other across separators, is put into the bag-shaped porous body made of a porous plastic film. Since the electrolytic solution spreads into the porous plastic film, it is possible to improve battery characteristics, particularly the cycle characteristic. Since it is not necessary to use adhesive tapes, which have been used to prevent the battery element stack from moving, there is also an advantageous effect of preventing the electrode from breaking from the attachment end face of the adhesive tape. In terms of producing and manufacturing, workability also improves.

### EXPLANATION OF REFERENCE SYMBOLS

1: Positive electrode
2: Negative electrode
3: Separator
4: Battery element stack
5: Bag-shaped porous body
6: Battery element stack/bag-shaped porous body complex
7: Positive terminal
8: Negative terminal
9: Film-like covering material
10: Stacked lithium ion secondary battery
20: Battery element stack
21: Adhesive tape

1. A stacked lithium ion secondary battery, characterized in that
a positive terminal is taken out from positive electrodes of a battery element stack in which the positive electrodes and negative electrodes are stacked via separators; a negative terminal is taken out from the negative electrodes; the battery element stack, except the taken-out portions of the positive and negative terminals, is covered with a porous plastic film; and an opening of the battery element stack covered with the porous plastic film is sealed with a film-like covering material.

2. The stacked lithium ion secondary battery according to claim 1, characterized in that
the battery element stack is sealed by thermal contraction of the porous plastic film.

3. The stacked lithium ion secondary battery according to claim 1, characterized in that
the porous plastic film has a porosity of 20% to 60% and a thickness of 20 μm to 100 μm.

4. The stacked lithium ion secondary battery according to claim 2, characterized in that
the porous plastic film has a porosity of 20% to 60% and a thickness of 20 μm to 100 μm.
